(19) United States
(12) Patent Application Publication
(10) Pub. No.: US 2005/0280170 A1
(43) Pub. Date: Dec. 22, 2005

(54) Methods and apparatus for fabricating optical elements

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/141,097

(22) Filed: May 31, 2005

(30) Foreign Application Priority Data
Jun. 18, 2004 (TW) 93117763

(51) Int. Cl. B29D 11/00

(52) U.S. Cl. 264/1.36; 264/1.38; 264/2.7; 425/808; 425/406

(57) ABSTRACT

A method for forming an optical element having a microstructure includes the steps of: providing a mold (30) having a pattern; disposing an optical perform (40) adjacent the mold with a portion thereof facing toward the predetermined pattern of the mold; heating the optical preform up to a predetermined temperature; hydrostatically pressing the mold onto the optical preform such that a to-be-processed portion of the optical preform is formed into the predetermined microstructure; and removing the mold from the treated optical preform to obtain the optical element. A hydrostatic pressing apparatus (55) is utilized to provide a uniform pressure applied to the mold. This ensures that the formed microstructure of optical elements having a high precision. In addition, the infrared quartz heaters are capable of instantly elevating the temperature of the optical preform. Thus, the whole process may be finished in a relatively short time.

### BACKGROUND

1. Field of the Invention

The present invention relates to a method and an apparatus for fabricating optical elements.

2. General Background

Optical elements, such as pick-up heads, are widely used in digital cameras, DVDs, and so on. Methods for fabricating the optical elements are developed rapidly. A typical method generally includes the steps of: placing a glass ingot in a mold, heating and pressing the glass ingot to form an optical element having an optical microstructure. Such method needs not include grinding and polishing steps.

A conventional method for fabricating optical elements includes the steps of: placing glass material into a mold, and heating the glass material to a predetermined temperature at which the glass material has a viscosity in the range from 10^{4.5}˜10⁶ poise. However, due to the unduly high molding temperature, a surface of the mold is liable to be damaged if the mold is kept contact with the glass material for a certain period of time. Thus, the precision of formed optical elements would be impaired.

Another conventional method for fabricating optical lenses is disclosed. A resin material is formed into Fresnel lenses by injection molding method. However, the Fresnel lenses have to be formed under a high temperatures for a certain period of time, which may cause occurrence of residual stresses. As a result, the precision of the optical microstructures of the Fresnel lenses may be impaired.

What is needed, therefore, is a method for fabricating optical elements which has fine precision.

### SUMMARY

In an exemplary embodiment, a method for forming an optical element having a microstructure includes the steps of: providing a mold having a pattern; disposing an optical perform adjacent the mold with a portion thereof facing toward the predetermined pattern of the mold; heating the optical preform up to a predetermined temperature; hydrostatically pressing the mold onto the optical preform such that a to-be-processed portion of the optical preform is formed into the predetermined microstructure; and removing the mold from the treated optical preform to obtain the optical element.

In the exemplary embodiment, a hydrostatic pressing apparatus is utilized to provide a uniform pressure applied to the mold. This ensures that the formed microstructure of optical elements having a high precision. In addition, the infrared quartz heaters are capable of instantly elevating the temperature of the optical preform. Thus, the whole process may be finished in a relatively short time.

Other systems, methods, features, and advantages of the present invention will be or become more apparent to one with skill in the art upon examination of the following drawings; in which:

### BRIEF DESCRIPTION OF THE DRAWINGS

FIG. 1 is a flow chart of a method for fabricating an optical element having a predetermined microstructure pattern in accordance with a preferred embodiment of the present invention;

FIG. 2 is a schematic, side cross-sectional view showing a silicon wafer having a photo-resist layer coated thereon, the silicon wafer is to be formed into a mold employed in the method of FIG. 1;

FIG. 3 is similar to FIG. 2, but showing the silicon wafer having a photo-resist pattern defined thereon;

FIG. 4 is similar to FIG. 3, but showing the first substrate after etching thereof has been completed;

FIG. 5 is similar to FIG. 4, but showing the first substrate after the photo-resist pattern has been removed;

FIG. 6 is schematic view showing a hot-press machine of the preferred embodiment; and

FIG. 7 is a schematic view of the formed optical element having the predetermined microstructure pattern.

### DETAILED DESCRIPTION OF PREFERRED EMBODIMENTS

Reference will now be made to the drawings to describe the embodiments of the present invention in detail.

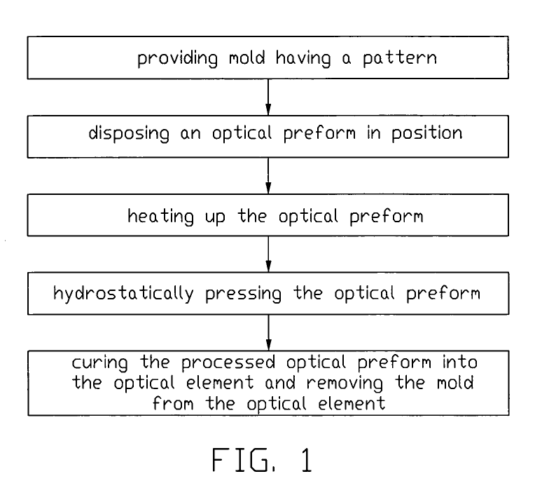

FIG. 1 is a flow chart of a method for fabricating an optical element having a predetermined microstructure pattern in accordance with a preferred embodiment of the present invention. The method mainly includes the following steps: providing a mold having a predetermined pattern corresponding to the predetermined microstructure pattern of the optical element, disposing an optical preform to be processed into the optical element adjacent the mold, heating the optical preform up to a predetermined temperature, hydrostatically pressing the mold to be onto the optical preform such that a portion of the optical preform is formed into the predetermined microstructure, and curing the processed optical preform into the optical element and removing the mold from the optical element. Each step of the exemplary method is described in more detail below.

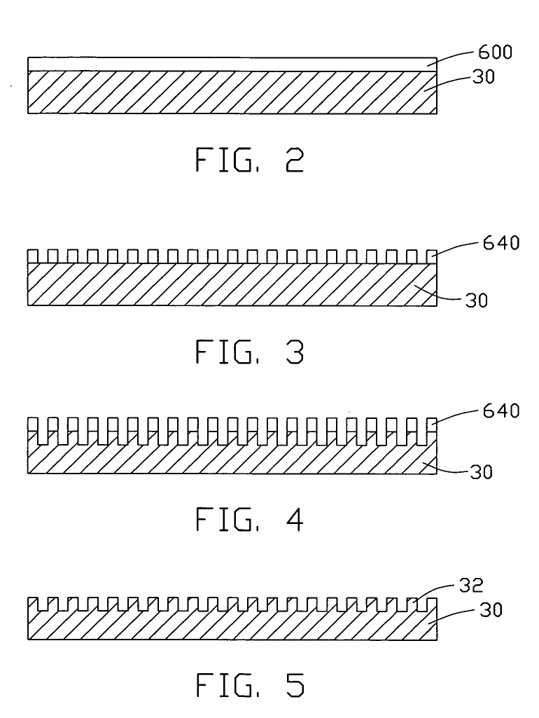

Referring to FIGS. 2˜5, a mold 30 is initially prepared. The mold 30 can be made of any of various hard ceramic materials such as silicon carbide (SiC) or tungsten carbide (WC). The mold 30 can also be made of glass. In the illustrated embodiment, the mold 30 is made from a silicon wafer. The silicon wafer is generally referred to as a substrate. The substrate 30 is baked in a vacuum or in a nitrogen environment under a temperature between 100° C. and 120° C. for 4˜6 minutes, for dehydration of the substrate 30. A photo-resist layer 600 is coated on a side surface of the substrate 30. The photo-resist layer 600 may comprise a negative or a positive photo-resist. In the illustrated embodiment, the photo-resist layer 600 comprises a negative photo-resist. The substrate 30 with the photo-resist layer 600 formed thereon is then baked under a temperature between 90° C. and 100° C. for 20˜30 minutes.

Referring to FIG. 3, a predetermined pattern of the photo-resist layer 600 is formed by lithography. The photo-resist layer 600 comprises exposed portions (not labeled) exposed to ultraviolet (UV) radiation, and unexposed portions (not labeled) covered by a photo-mask (not shown) having a predetermined pattern. Exposed portions 640 of the photo-resist layer 600 are subjected to the UV radiation such that the exposed portions 640 become resistant to being dissolved in a developer.

The treated substrate 30 is baked under a temperature between 100° C. and 120° C. for 20˜30 minutes, in order to increase a resistance to solubility of the exposed portions 640 of the photo-resist layer 600 in the developer.

Then, the developer which is capable of dissolving the negative photo-resist is sprayed onto the photo-resist layer 600. Generally, the unexposed portions of the photo-resist layer 600 are fully dissolved after 30˜60 seconds. Only the exposed portions 640 of the photo-resist layer 600 remain, and cooperatively form a photo-resist pattern 640.

Referring to FIG. 4, the substrate 30 is etched, which is performed by way of dry etching, such as sputter etching, ion beam etching, plasma etching, or reactive ion etching. First portions of the substrate 30 that are not covered by the photo-resist pattern 640 are etched and removed, and second portions of the first substrate 30 that are covered by the photo-resist pattern 640 are protected from being etched.

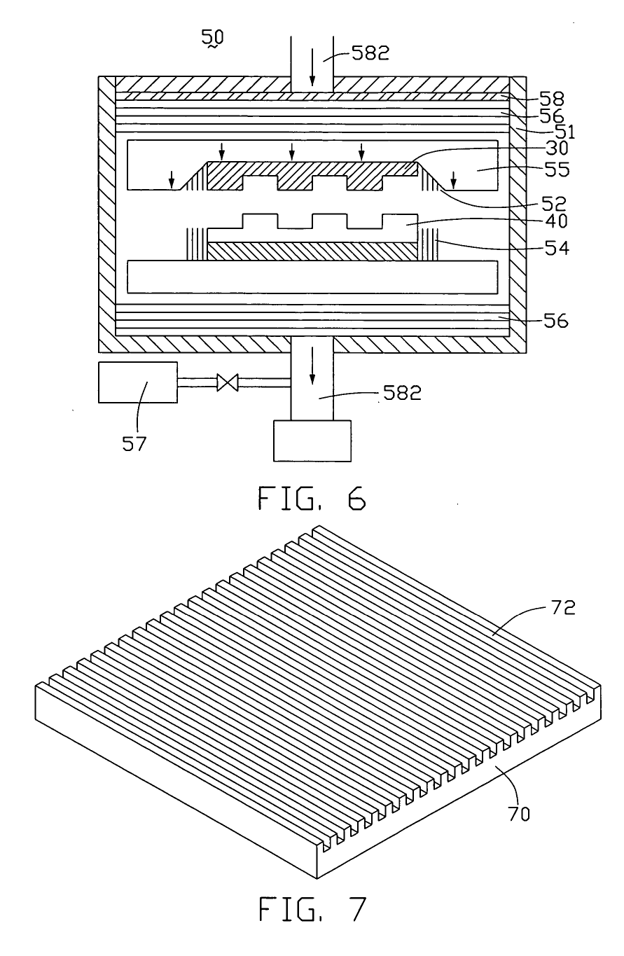

Referring to FIG. 5, the remaining photo-resist pattern 640 on the substrate 30 is removed, and the resultant mold 30 with a predetermined microstructure pattern 32 defined thereon is obtained. The obtained microstructure pattern 32 is the same as the pattern of the photo-mask. In the illustrated embodiment, the microstructure 32 comprises a plurality of net-dots.

Referring to FIG. 6, a hot-press machine 50 is shown. The hot-press machine 50 includes an enclosure 51, a hydrostatic press apparatus 55, a support (not labeled), two heating elements 56, an ultraviolet curing device 58, a coolant channel 582, and a temperature control system (not shown). The enclosure 51 comprises a chamber. The chamber is for containing a working fluid or a working gas therein, and includes an inlet and an outlet. Hydrostatic pressures are created by introducing the working fluid or the working gas into the chamber. The hydrostatic pressing apparatus 55 has a cavity for receiving the mold 30 therein. The support defines a second receiving portion 54 for receiving the optical preform therein. The support is arranged adjacent the hydrostatic pressing apparatus 55, such that the second receiving portion 54 correspondingly faces toward the first receiving portion 52. The enclosure 51 is operable to disengage the mold 30 from the optical preform by means of a driving mechanism. The driving mechanism may be a pneumatic mechanism, a hydraulic mechanism, or a mechanical mechanism. The heating elements 56 are generally infrared quartz heaters. The curing device 58 is generally an ultraviolet curing device. The temperature control system generally includes a thermocouple or an optical pyrometer. The process of the present invention can be performed in vacuum or in an air environment. In the illustrated embodiment, the process is performed in vacuum. The hot-press machine 50 further comprises a reaction chamber (not shown) and a vacuum pump 57 for adjusting a degree of vacuum inside the reaction chamber.

An optical preform 40 is prepared. The optical preform 40 may be made of polymethyl methacrylate. The optical preform 40 may also be made of polyacrylic, polycarbonate, or polyethylene. The mold 30 is disposed in the first receiving portion 52, with the microstructure pattern 32 thereof facing toward the second receiving portion 54. The optical preform 40 is disposed in the second receiving portion 54 with a portion or portions to be processed facing toward the microstructure pattern 32 of the mold 30.

As stated above, the chamber of hydrostatic pressing apparatus 55 may contain working fluid or working gas therein. In the illustrated embodiment, a working gas is introduced into the chamber of hydrostatic pressing apparatus 55. A temperature of the working gas is controlled by the temperature control system. The optical preform 40 is heated by means of the heating elements 56 up to a phase transformation temperature thereof. In the present embodiment, the phase transformation temperature of polymethyl methacrylate is about 108° C. When the temperature of the optical preform 40 is 108° C., the mold 30 is pressed onto the optical preform 40 by the hydrostatic pressing apparatus 55 such that the portion or portions of the optical preform 40 to be processed is/are formed into a predetermined microstructure.

The heating elements 56 are powered off. The ultraviolet curing device 58 is turned on to cure the optical preform 40 into the desired optical element. Cool water or air is then introduced into the hot-press 50 through the coolant channel 582, in order to cool the cured optical preform 40. Referring to FIG. 7, the mold 30 is removed from the cured optical preform 40, and the optical element 30 with a microstructure 32 formed thereon is thus obtained. In the illustrated embodiment, the microstructure 32 is a grating.

In the exemplary embodiment, the hydrostatic pressing apparatus 55 is utilized to provide a uniform pressure applied to the mold 30. This ensures that the formed microstructure of optical elements having a high precision. In addition, the infrared quartz heaters are capable of instantly elevating the temperature of the optical preform. Thus, the whole process may be finished in a relatively short time.

It is to be further understood that even though numerous characteristics and advantages of the embodiments have been set forth in the foregoing description, together with details of the steps, structure, and function of the embodiments, the disclosure is illustrative only, and changes may be made in detail, especially in matters of steps, shape, size, and arrangement of parts within the principles of the invention to the full extent indicated by the broad general meaning of the terms in which the appended claims are expressed.

1. A method for forming an optical element having a microstructure, comprising the steps of:
(a) providing a mold having a pattern;
(b) disposing an optical preform adjacent the mold with a portion thereof facing toward the predetermined pattern of the mold;
(c) heating the optical preform up to a predetermined temperature;
(d) hydrostatically pressing the mold onto the optical preform such that a to-be-processed portion of the optical preform is formed into the predetermined microstructure; and
(e) removing the mold from the treated optical preform to obtain the optical element.

2. The method as claimed in claim 1, wherein step (a) comprises the steps of:
providing a substrate, forming a photo-resist layer on the substrate, and forming the predetermined pattern on the substrate by lithography.

3. The method as claimed in claim 2, wherein the substrate is made of silicon or glass.

4. The method as claimed in claim 1, wherein the optical preform is made of polymethyl methacrylate, polyacrylic, polycarbonate, or polyethylene.

5. The method as claimed in claim 1, wherein in step (c), the predetermined temperature of the optical preform is heated up by means of an infrared quartz heater.

6. The method as claimed in claim 1, further comprising the step of, after step (d) and prior to step (e), curing the processed optical preform into the optical element.

7. The method as claimed in claim 6, wherein the processed optical preform is cured by means of an ultraviolet curing device.

8. A forming apparatus comprising:
a first receiving portion for receiving a mold for fabricating an optical element having a microstructure;
a second receiving portion for receiving an optical preform to be processed into the optical element, the second receiving portion corresponding to the first receiving portion such that the optical element to be received therein spatially corresponds to the mold;
a heating element for heating the optical preform up to a predetermined temperature;
a hydrostatic pressing apparatus for hydrostatically pressing the mold to the optical preform when the optical preform is heated up to the predetermined temperature; and
an enclosure enclosing the first and second receiving portions, the heating element and the hydrostatic pressing apparatus therein.

9. The forming apparatus as claimed in claim 8, wherein the heating element is an infrared quartz heater.

10. The forming apparatus as claimed in claim 8, further comprising an ultraviolet curing device for curing the optical preform.

11. The forming apparatus as claimed in claim 8, wherein the hydrostatic pressing apparatus comprises a chamber for containing a working fluid or a working gas.

12. The forming apparatus as claimed in claim 11, further comprising a temperature control system for controlling a temperature of the working fluid or the working gas.

13. The forming apparatus as claimed in claim 12, wherein the temperature control system comprises a thermocouple or an optical pyrometer.

14. The forming apparatus as claimed in claim 8, further comprising a reaction chamber for receiving the mold and the optical preform therein.

15. The forming apparatus as claimed in claim 14, further comprising a vacuum pump for adjusting a degree of vacuum inside the reaction chamber.

16. The forming apparatus as claimed in claim 8, further comprising a coolant channel for introducing coolant into the forming apparatus to cool the processed optical preform.

17. A method for forming an optical element having a predetermined microstructure, comprising the steps of:
equipping a mold with a pattern corresponding to said microstructure;
placing an optical perform readily to transform to said optical element beside said mold with a portion thereof facing said pattern of said mold;
uniformly pressing said optical perform by means of said mold to form said microstructure on said portion of said optical perform; and
removing said mold from said optical perform to acquire said optical element.

18. The method as claimed in claim 17, wherein said uniformly pressing is achieved by a hydrostatically-driven way.

19. The method as claimed in claim 17, further comprising the step of heating said optical preform up to a predetermined temperature before said uniformly-pressing step.
